(19) United States
(12) Patent Application Publication
(10) Pub. No.: US 2003/0085605 A1
(43) Pub. Date: May 8, 2003

(54) Seat and headrest system

(76) Inventor: William J. Hentges, Plymouth, MI (US)

Correspondence Address: Price, Heneveld, Cooper, DeWitt & Litton, 695 Kenmoor, S. E., Post Office Box 2567, Grand Rapids, MI, 49501, US

(21) Appl. No.: 10/289,065

(22) Filed: Nov. 6, 2002

Related U.S. Application Data
(60) Provisional application No. 60/345,997, filed on Nov. 7, 2001.

(51) Int. Cl. B60N 2/02

(52) U.S. Cl. 297/378.1

(57) ABSTRACT

A headrest mounting housing is adapted to be mounted to a vehicle in relationship to seats for holding a headrest. Associated with the headrest is a seat having a seat back which can move to a position in which the headrest functions in association with the seat back to a horizontal position for storage of items without the need for moving the headrest. The headrest storage housing may include a roll-up security screen for covering items stored on the seat back when lowered to a horizontal storage position. In one preferred embodiment, the seat back includes a recess into which the headrest housing is nested to provide an integrated appearance to the headrest and seat back.

### CROSS-REFERENCE TO RELATED APPLICATIONS

This application claims priority under 35 U.S.C. § 119(e) on U.S. Provisional Application No. 60/345,997 entitled SEAT AND HEADREST SYSTEM, filed on Nov. 7, 2001, by William J. Hentges, the entire disclosure of which is incorporated herein by reference.

### BACKGROUND OF THE INVENTION

The present invention relates to a vehicle seating structure and particularly to an improved headrest and seat combination.

Multipurpose vehicles, such as sport utility vehicles, vans and the like which have a variety of seat configurations, are employed for numerous uses, such as shopping, transportation of children to and from school activities, heavy duty hauling and the like. With such vehicles, the seats typically can be moved between normal seating positions and various lowered and raised positions, or removed to accommodate different storage and transportation needs. Typically such seats also include a headrest mounted to a headrest stalk extending from the seat back.

In order to pivot a seat forwardly, it is necessary to remove the headrest and place the headrest in a storage slot, such that the seat back can be pivoted forwardly to a generally horizontal position for storage of items thereon. This construction makes it somewhat cumbersome and difficult for the vehicle operator to easily convert an upright seat back to a horizontal supporting surface inasmuch as one or more headrests must be removed and repositioned. There is a need, therefore, for a seating system in which adjustable storage seats can be easily repositioned without the need for removing and repositioning headrests.

### SUMMARY OF THE INVENTION

The system of the present invention overcomes the difficulties with prior art seating arrangements by providing in one embodiment a headrest mounting housing at the rear wall of a vehicle, such as a crew or king cab vehicle, for holding a plurality of headrests in a fixed location but in vertically adjustable relationship to the vehicle. In one embodiment, associated with the headrest housing is a seat having a seat back which can move to a position in which the headrest functions in association with the seat back to a horizontal position for storage of items without the need for moving the headrests. The headrest housing may include a roll-up security screen for covering items stored on the seat back when lowered to a horizontal storage position. In one preferred embodiment of the invention, the seat back includes a recess for receiving the headrest housing in nesting relationship to provide an integrated appearance to the headrest and seat back.

These and other features, objects and advantages of the present invention will become apparent upon reading the following description thereof together with reference to the accompanying drawings.

### BRIEF DESCRIPTION OF THE DRAWINGS

FIG. 1 is a fragmentary perspective view of a vehicle embodying the present invention;

FIG. 2 is a fragmentary perspective view of the vehicle shown in FIG. 1, shown with the seat back in a lowered position and the security screen extended from a headrest housing;

FIG. 3 is a rear fragmentary perspective view of another embodiment of the present invention, shown with the seat back in an upright position;

FIG. 4 is a rear perspective view of the structure shown in FIG. 3, shown with some of the seats lowered to storage positions;

FIG. 5 is an enlarged fragmentary perspective view, partly broken away, showing storage of items in the system of either embodiment of the present invention;

FIG. 6 is a vertical cross-sectional view of the inter-relationship between the headrest housing and seat back in one embodiment of the invention;

FIG. 7 is a vertical cross-sectional view of the inter-relationship between the headrest housing and seat back in another embodiment of the invention;

FIG. 8 is an enlarged fragmentary perspective view of another embodiment of the present invention shown in a first position;

FIG. 9 is an enlarged fragmentary perspective view of yet another embodiment of the present invention shown in a different position; and

FIG. 10 is a fragmentary perspective view of a further embodiment of the invention.

### DETAILED DESCRIPTION OF THE PREFERRED EMBODIMENT

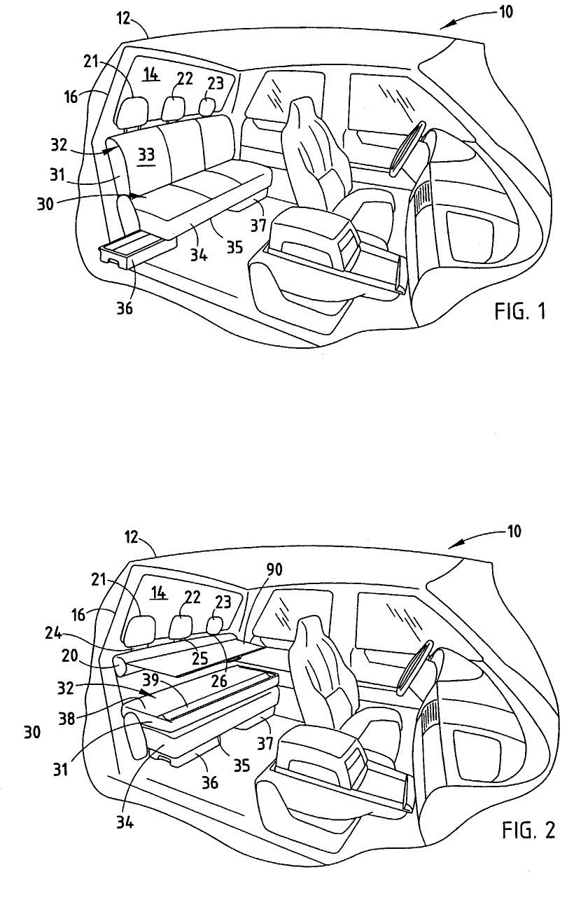

FIG. 1 shows a vehicle 10, such as a crew or king cab pickup truck, having a cab 12 with a rear window 14 and a rear wall 16 to which there is mounted, as seen in FIG. 2, a housing 20 for holding a plurality of headrests 21, 22, and 23. The headrests are mounted to housing 20 by means of stalks 24, 25 and 26, respectively, which are secured in fixed relationship to the vehicle wall 16. The headrests themselves are vertically adjustable on their associated stalk for accommodating different passengers. Housing 20 is positioned behind and concealed by the back 32 of a rear seat 30 which includes a seating section 34 with a bottom 35 for receiving storage trays 36 and 37 slidably mounted to the bottom of seat 34 for extending from opposite sides of the vehicle. Tray 36, for example, is shown in FIG. 1 in an extended position for access. The seat back 32 includes a passenger back support surface 33 and a rear surface 38 (FIG. 2), which is substantially horizontal when the seat back is folded down to accommodate and store items thereon, as seen in FIG. 2. The seat back 32 can be latched utilizing a conventional latch mechanism for holding the seat in the upright position shown in FIG. 1 and is releasable, allowing the seat to be pivoted downwardly to a storage position, as shown in FIG. 2. Seat back 32 also includes left and right side ends 31.

In one embodiment of the invention, as shown in FIGS. 2 and 6, the rear surface 38 of seat back 32 includes an elongated semicylindrical recess 39 which is shaped to conform to and receive the headrest housing 20. Recess 39 extends the length of the housing 20, which is somewhat shorter than the overall width of seat back 32, such that ends 31 of the seat back conceal the housing 20, as seen in FIG. 1, when the seat back is in its raised position, thereby providing the appearance of a seat with an integrated headrest.

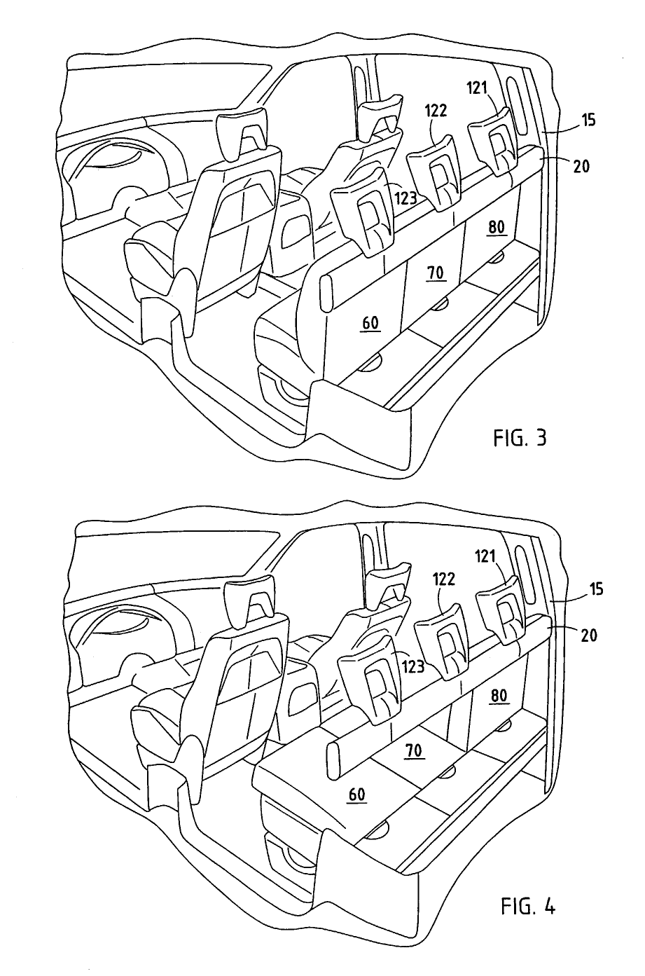

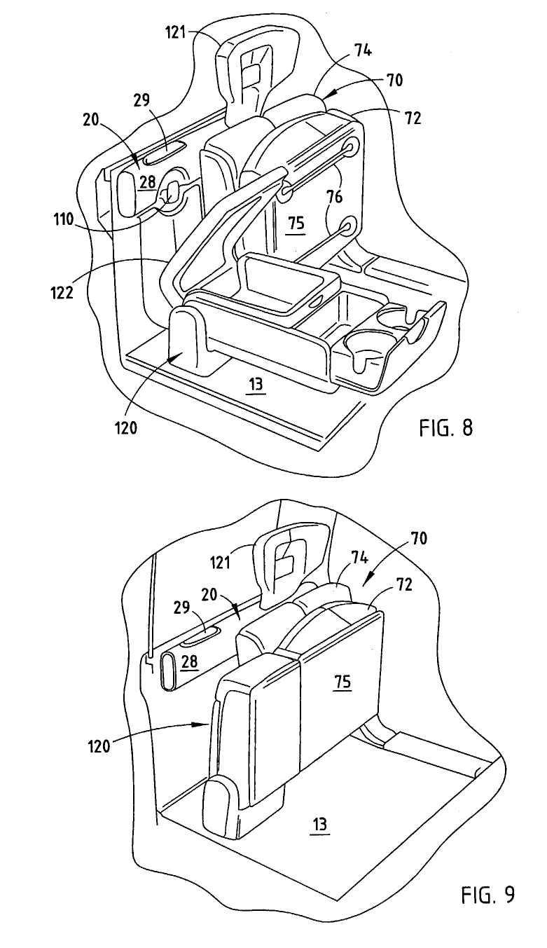

In another embodiment of the invention as shown in FIGS. 3 and 4, the rear seat of the cab is divided into three seat back sections 60, 70, and 80, which are independently movable between such that the storage area can be adjusted by independently lowering one, two, or three of the seats, with two of the seats being shown lowered into a storage position as seen in FIG. 4. The same headrest housing 20 is mounted either to the back wall 16 of the vehicle or between the side pillars 15 (one shown) of the vehicle adjacent the rear wall 16 as in the first embodiment or at an intermediate position in longer vehicles. Housing 20 supports adjustable headrests 121, 122, and 123 thereon, as in the first embodiment. The seat backs 60, 70, and 80 are pivotally mounted and releasably latched in a conventional manner between the upright position shown in FIG. 3 and a lowered, folded down position shown in FIG. 4 with the headrest remaining in a stationary position as seen in FIG. 4 when the seats are lowered. Each of the three seat backs 60, 70, and 80 can be individually moved to provide flexible storage for the rear area of the vehicle. The seat backs may have a side profile, as illustrated in FIG. 6, such that the rear surfaces, such as semicylindrical recess surface 39 in FIG. 6, lie adjacent and/or in contact with housing 20 to conceal the housing when the seat backs are in the raised position, as shown in FIG. 3. Alternatively, the construction of FIG. 7 with an offset headrest stalk 25 can also be employed. With either embodiment, the seat presents an integrated appearance with the headrest and allows storage of items on the horizontally extending backs of the seats when in a lowered position.

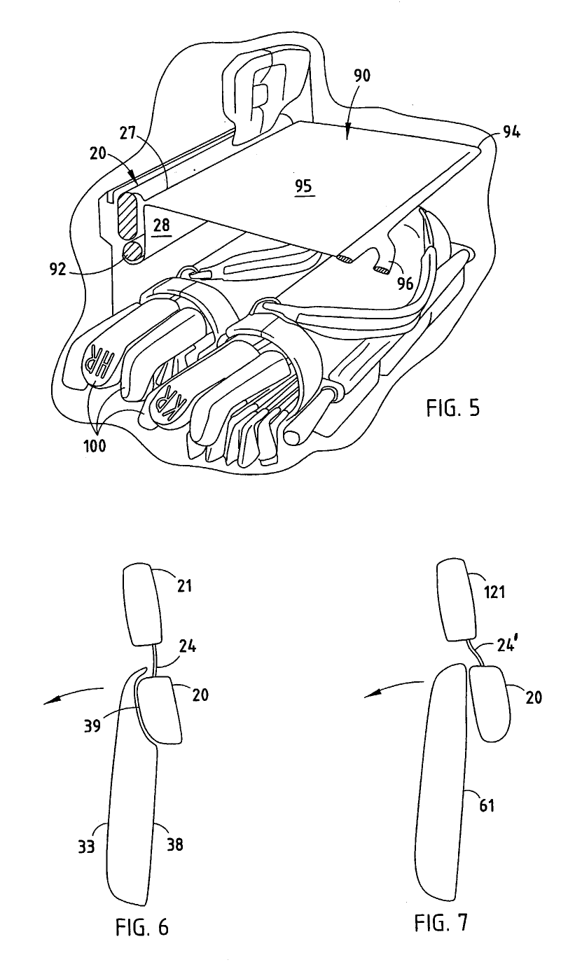

FIGS. 2 and 5 illustrate the mounting of a security screen 90 within the housing 20 using a conventional roller shade type cylinder 92 (FIG. 3) which is spring-loaded to allow the sheet material 95 of screen 90 to extend through a slot 27 in the forward facing wall 28 of housing 20. Security screen 90 includes a forward cross member 94 and handle 96 for conveniently withdrawing the screen from the headrest housing 20 to cover items such as golf bags 100, resting on the backs of seats 60, 70, and 80 in, for example, FIGS. 3, 4, and 5. In the embodiment of FIGS. 1 and 2, the handle 96 may attach to a hook (not shown) on the back of a front seat or screen sheet 95 may be over stored items.

FIG. 8 illustrates the mounting of one or more integral hooks 110 to the front facing surface 28 of headrest housing 20, which can accommodate items with handles for storage when the seat backs are lowered or if the seats are removable-type seats and are removed to allow a storage console such as console 120, to be mounted to the vehicle floor 13 in place of one of the seats. Housing 20 in FIG. 8 includes a headrest 121 which is positioned to align with one of the seats, such as a seat 70, and, as in the embodiment shown in FIGS. 3 and 4, seat 70 includes a seating section 72 and seat back 74 which can be moved to numerous positions to accommodate storage of various items. In FIG. 8 and in the embodiment of FIG. 9, the seat back is raised and latched adjacent the headrest housing 20, as is the seating section 72. The bottom 75 of seating section 72 may include elastic straps 76 for holding items between the seat bottom 75 and straps 76. In the embodiment shown in FIGS. 8 and 9 if desired, the headrest 21 can be removed from a socket 29 formed in the upper surface of housing 20. FIG. 9 shows the console 120 in a closed and raised position providing a larger storage area on floor 13 of the vehicle.

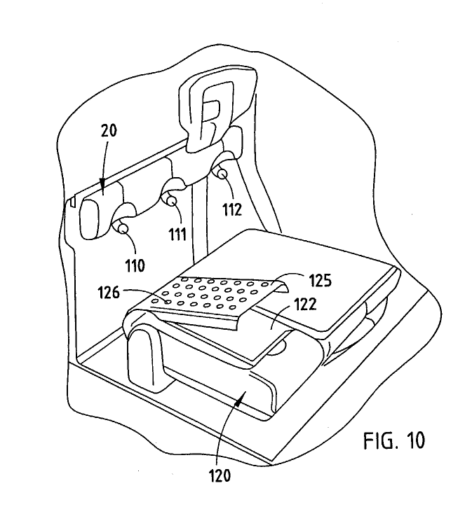

The embodiment of FIG. 10 is similar to that shown in FIGS. 8 and 9 except that a plurality of spaced hooks 110, 111, and 112 are shown extending across the headrest housing 20 and a protective pivoted shield 125 is provided over the console 120 for protecting the console surface when abrasive items may be held by hook 110 and supported on the surface of the shield 125, which typically will be made of a rigid polymeric material to protect the upholstery of console cover 122. Alternatively, cover 122 may be a waterproof tray and shield 125 perforated, as shown with apertures 126, to allow wet items to be stored on shield 125.

In each of the embodiments, the headrests are mounted to a housing or bar which remains fixed to the vehicle frame or wall such that the seat backs associated with the headrests can be moved without the need for removing the headrest from the seat backs, thereby allowing a greater degree of flexibility of seat combinations to be used for presenting a variety of storage options.

Although the invention is described in the environment of the rear cab section of a pickup truck, it could be employed with a single cab pickup truck, sports utility vehicle, or any other vehicle to which the fixed housing can be mounted in some manner adjacent the top of a seat back. It will become apparent to those skilled in the art that these and various other modifications to the preferred embodiment of the invention as described herein can be made without departing from the spirit or scope of the invention as defined by the appended claims.

The invention claimed is:

1. A seat system comprising:
a seat having a seat section and a seat back which is mounted to a vehicle, such that said seat back can move between a raised back supporting position and a lowered generally horizontal stored position for storing items thereon; and
a housing extending near the top of the seat back and adapted to be mounted in fixed relationship to a vehicle independent from said seat, said housing including at least one headrest mounted thereto for providing a headrest associated with a seat back when in a raised back supporting position.

2. The seat system as defined in claim 1 wherein said housing includes an extendable security cover mounted therein.

3. The seat system as defined in claim 1 wherein said seat back includes a rear surface facing said housing and said rear surface includes a recess for nestably receiving said housing therein when said seat is in an upright back supporting position.

4. The seat system as defined in claim 1 wherein said seat section includes a seat supporting section and a bottom, and wherein said bottom includes at least one storage tray slidably mounted therein.

5. The seat system as defined in claim 1 and further including a plurality of hooks extending from said housing for holding items thereon.

6. A headrest mounting system for use in a vehicle with a seat having a seat section and a seat back which is mounted to a vehicle, such that said seat back can move between a raised back supporting position and a lowered generally horizontal stored position for storing items thereon, comprising:
a housing extending near the top of the seat back and adapted to be mounted in fixed relationship to a vehicle, said housing including at least one headrest mounted thereto for providing a headrest for the seat back when in a raised back supporting position.

7. The headrest mounting system as defined in claim 6 wherein said housing includes an extendable security cover mounted therein.

8. The headrest mounting system as defined in claim 6 and further including a plurality of hooks extending from said housing for holding items thereon.

9. A seat and headrest system comprising:
a seat having a seat section and a seat back which is mounted to a vehicle, such that said seat back can move between a raised back supporting position and a lowered generally horizontal stored position for storing items thereon; and
a housing extending near the top of the seat back and adapted to be mounted in fixed relationship to a vehicle, said housing including at least one headrest mounted thereto for providing a headrest for the seat back when in a raised back supporting position, wherein said housing includes an extendable security cover mounted therein.

10. The seat and headrest system as defined in claim 9 wherein said seat back includes a rear surface facing said housing and said rear surface includes a recess for nesting said housing therein when said seat is in an upright back supporting position.

11. The seat and headrest system as defined in claim 10 and further including a plurality of hooks extending from said housing for holding items thereon.

12. The seat and headrest system as defined in claim 11 wherein said seat section includes a seat supporting section and an under surface, and wherein said under surface includes at least one storage tray slidably mounted therein.
